(19) United States
(12) Patent Application Publication
(10) Pub. No.: US 2004/0079015 A1
(43) Pub. Date: Apr. 29, 2004

(54) Advertisement/pamphlet holder

(76) Inventor: J. Robin Tuttle, Rockford, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/656,485

(22) Filed: Sep. 5, 2003

Related U.S. Application Data
(60) Provisional application No. 60/420,559, filed on Oct. 23, 2002.

(51) Int. Cl. G09F 3/18

(52) U.S. Cl. 40/661

(57) ABSTRACT

A holder including a pocket for holding informational material and an extension extending from the pocket, which is adapted for engagement by a window pane when the window pane is in an at least a generally closed position.

This application claims priority from provisional application entitled ADVERTISEMENT/PAMPHLET HOLDER, Ser. No. 60/420,559, filed Oct. 23, 2002, which is incorporated herein by reference in its entirety.

### TECHNICAL FIELD AND BACKGROUND OF THE INVENTION

The present invention generally relates to a holder that is particularly suitable for use in holding advertising or promotional material, including pamphlets, in a manner to provide easy access to the advertising material and, further, which is especially suitable for use with a vehicle.

When selling a vehicle, many owners place a poster or sign in one of the windows of the vehicle. The poster or sign typically includes the price of the vehicle and the telephone number where the owner can be reached. It is also common practice to park a vehicle for sale in a parking lot where people can stop and inspect the vehicle, at least from the exterior, and if interested can jot down the telephone number of the owner so that the potential purchaser can obtain further information about the vehicle.

However, when shopping for vehicles, most shoppers would prefer more information about the vehicle prior to contacting the seller of the vehicle. This is even true when shopping for vehicles at a dealership. In dealership parking lots, a car typically includes a sticker that is mounted to the inside of side window, which includes not only the price of the vehicle but also the options the vehicle carries. While an abundance of information may be provided, many shoppers would prefer the information in a transportable form that would allow the shopper to take the information home for further examination and for comparison purposes.

Consequently, there is a need for a device that will allow a potential purchaser of a product or item, such as a vehicle, to obtain more detailed information about the item prior to contacting the seller or a sales person, but in a transportable form so that they can take the information with them for further evaluation and/or comparison.

### SUMMARY OF THE INVENTION

Accordingly, the present invention provides a holder for holding and making accessible informational material. The holder includes a pocket and an extension, which extends from the pocket. The extension is adapted for engagement by a window pane, such as a window pane of a vehicle, when the window pane is in at least a generally closed position.

In one form, the pocket is formed by at least one sheet of plastic. For example, the sheet of plastic may comprise a clear plastic sheet. In addition, the sheet of plastic may form the extension.

In other aspects, the extension includes a looped portion, which is adapted for holding a cylindrical member such that the cylindrical member forms a stop when the extension is draped over the top edge of the window pane and the window pane is at least partially closed.

In other aspects, the holder includes a second pocket. For example, the second pocket may be located intermediate the first pocket and the extension. Furthermore, the extension may include the second pocket.

In another aspect, the pocket has an opening for inserting therein and retrieving therefrom the informational material. Optionally, the holder further includes a cover for at least partially closing the opening. For example, the cover may comprise a flap and optionally include a fastener member, with the pocket including a corresponding fastener member that cooperates with the fastener member of the flap to close the opening. Suitable fastener members include hook and loop members.

In yet a further aspect, the pocket includes an upper edge when the holder is mounted in the window, with the extension extending from the upper edge. Optionally, the opening may be located at the upper edge of the pocket or may be located at a side edge or bottom edge of the pocket.

From the foregoing, it can be appreciated that the present invention provides a holder that is particularly suitable for holding advertisements or marketing materials, such as pamphlets or flyers, that can be quickly and easily retrieved from the holder and, further, which is especially suitable for use in a vehicle.

These and other objects, advantages, purposes, and features of the invention will become more apparent from the study of the following description taken in conjunction with the drawings.

### DETAILED DESCRIPTION OF THE DRAWINGS

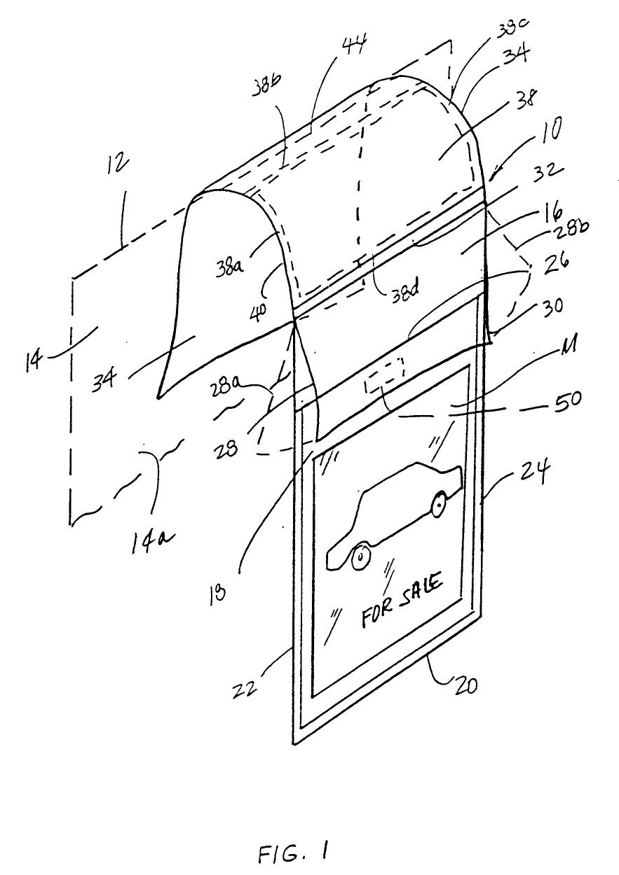

FIG. 1 is a perspective view of one embodiment of the advertising/promotional material holder of the present invention shown mounted in a window;

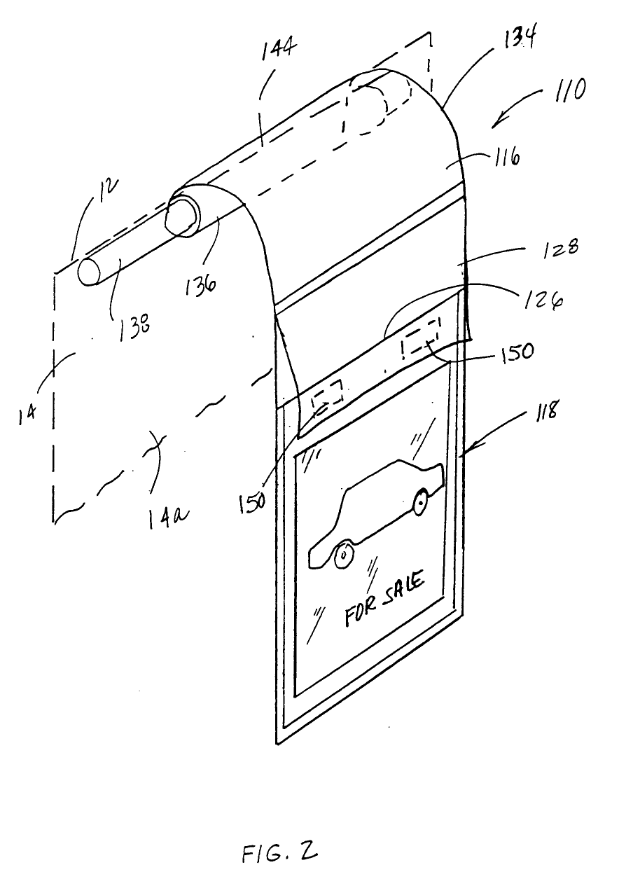

FIG. 2 is another embodiment of the holder of the present invention; and

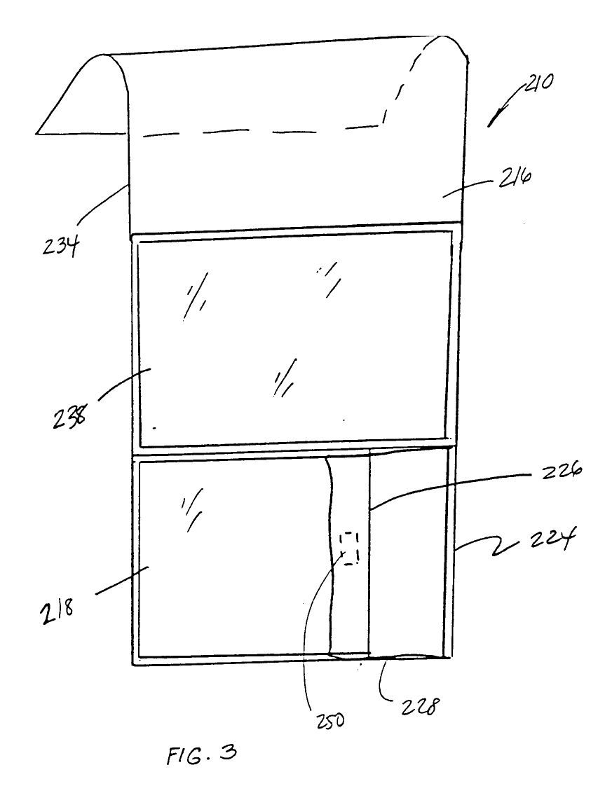

FIG. 3 is a third embodiment of the holder of the present invention.

### DETAILED DESCRIPTION OF THE PREFERRED EMBODMIMENTS

Referring to FIG. 1, the numeral 10 generally designates a holder of the present invention. Holder 10 is particularly suitable for holding advertisements or marketing materials M, such as pamphlets or flyers, and, further, for use in a window or door, such as in a vehicle window. As best understood from FIG. 1, holder 10 may be looped over an upper edge 12 of a window pane 14, for example, of a vehicle. As would be understood, when window pane 14 is moved to its closed position, the upper edge 12 of window pane 14 will pinch and grasp the holder between the pane and the frame of the door or body to thereby secure the holder to the vehicle against the outer surface 14a of the window pane so that potential purchasers of the item being advertised may retrieve information material, which is housed in holder 10.

In the illustrated embodiment, holder 10 is formed from a sheet of material, such as plastic, including clear, opaque plastic, colored and/or tinted plastic. Holder 10 includes at least one pocket 18, which is formed either from the end of sheet 16, which may be folded over and sealed along its lower edge 20 and side edges 22 and 24, for example by an adhesive, stitches, or a weld, including stitch welds. Upper edge 26 of the sheet forms an opening to provide access into the cavity of the pocket 18, where the promotional material may be inserted for storage. It should be understood that pocket 18 may be formed from a separate sheet of material, which is similarly adhered, stitched, or welded (or a combination of any one of these methods) at its lower and side edges 20, 22, and 24 to sheet 16. The separate sheet may comprise the same material as sheet 16 or may comprise a different material.

Optionally, holder 10 includes a cover 28, which is formed by a sheet of material 30 similar to sheet 16. Alternately, cover 28 may be formed by a different material. Cover 28 comprises a flap that is connected at its upper edge 32 to sheet 16 by, for example, an adhesive, stitches, or a weld similar to how pocket 18 is formed. Alternately, cover 28 may be formed from the upper end of sheet 16 folded over in a similar manner to pocket 18 with a fold at its upper edge 32 similarly formed by an adhesive, stitches, or a weld, including a stitch weld.

Holder 10 further includes an extension 34, which extends upwardly from pocket 18. Extension 34 similarly comprises a sheet of material similar to sheet 16 and is positioned over edge 12 of window pane 14 and, further, to be engaged by window pane 14 when window pane 14 is moved to its closed position, as noted above. Preferably, extension 34 has sufficient length so that the free end 34a of extension 34 may be held while window pane 14 is moved to its closed position. Optionally, extension 34 may be an extension of sheet 16 and may be otherwise attached to sheet 16 by an adhesive, stitches, or a weld, including a stitch weld, similar to cover 28. Furthermore, extension 34 may include a second pocket 38 formed therein, which may be used to insert additional information, such as additional marketing material, an advertisement, or signage, such as ‘for sale’ signage, or the like. Pocket 38 may be similarly formed to pocket 18 and may include an open side along any one of its edges, namely edges 38a, 38b, 38c, and 38d. Optionally, the opening may be located on the inner side 40 of extension 34 to protect the advertisement from water damage. Alternately, the opening may be protected by a cover or flap similar to opening 26.

Optionally, cover 28 may include one or more fasteners 50, such as VELCRO fasteners (hook and loop fasteners) to close cover 28 over opening 26. To provide an enhanced sealing of opening 26, cover 28 may include extensions 28a, 28b on one or more sides which can be wrapped behind sheet 16 and optionally secured in place by additional fasteners, such as VELCRO patches or the like.

In use, holder 10 is positioned such that extension 34 is draped over upper edge 12 of window pane 14. Optionally, holder 10 may have a crease or seam 44 at its medial portion that permits holder 10 to be generally flush with the exterior surface 14a of pane 14. To secure holder 10 in place, window pane 14 is moved to its closed position to thereby pinch a medial portion of extension 34 between window pane 14 and the frame of the door or body. It should be understood that holder 10 may be used in other applications, for example over doorways or windows of a building or the like. As noted above, holder 10 is preferably formed from one or more sheets of plastic, which are assembled together either by welds or adhesive. It should be understood that the various sheets of material forming holder 10 may also be assembled by stitching or the like. In addition, one or more of the components forming holder 10 may be formed from a fabric material in which case the holder is preferably assembled using stitching or an adhesive.

Referring to FIG. 2, the numeral 110 generally designates another embodiment of the present invention. Holder 110 is of similar construction to holder 10 and is formed from a sheet 116 of material, such as plastic, and includes a pocket 118 similar to pocket 18 and a cover 128, similar to cover 28. In addition, holder 110 includes an extension 134, which is similarly adapted to be engaged by a window pane 14 when the window pane is substantially moved its closed position.

In the illustrated embodiment, extension 134 includes a looped portion 136 that is sized to receive a cylindrical member 138, such as a rod, pencil or the like, which forms an abutment or stop that retains holder 110 against window pane 14 when window pane 14 is moved to its substantially closed position. As will be understood, extension 134 is draped over upper edge 12 of pane 14. When pane 14 is moved to its closed or substantially closed position, stop 138 will be trapped by the upper edge of window pane 14 in the vehicle to retain holder 110 against window pane 14. Similar to the previous embodiment, extension 134 may include a crease or seam 144 provided at a generally medial portion of extension 134, which is preferably aligned with upper edge 12 window pane 14 when holder 110 is mounted in the window so that holder 110 will lie substantially flush against the exterior surface 14a of window pane 14. Seam 144 may be formed by a weld, which runs along the width of holder 110 or may be formed by stitching.

In addition, holder 110 may incorporate a second pocket similar to pocket 38 described in reference to the first embodiment and, further, may include more than one fastener members 150 similar to fastener 50 to thereby close cover 128 over opening 126 of pocket 118.

Referring to FIG. 3, the numeral 210 designates another embodiment of the holder of the present invention. Holder 210 is of similar construction to the previous holders and is formed from a sheet of material 216, such as plastic, and includes a first pocket 218 and a second pocket 238 for holding informational and advertising material therein. For details of optional constructions of holder 210, reference is made to the previous embodiments.

Similar to holders 10 and 110, holder 210 includes an extension 234, which is adapted for engagement by a window pane of, for example, a vehicle. In contrast to the first embodiment, pocket 218 includes a generally vertical opening 226, which is located at or near edge 224 of pocket 218. Similar to the previous embodiments, opening 226 is closed by a cover 228, which is attached or formed at or near edge 224 to thereby close opening 226. Optionally and preferably, cover 228 includes one or more fasteners 250 for retaining cover 228 in its closed position.

While several forms of the invention have been shown and described, other variations will be understood by those skilled in the art. As previously mentioned, sheets 16, 116, and 216 may be formed from a fabric material in which case, it is preferable to provide a clear plastic panel to form the respective pockets so that the advertising or informational material may be viewed from the side facing outwardly from the vehicle when the holder is mounted in a vehicle. The embodiments shown in the drawings and described above are merely for illustrative purposes, and are not intended to limit the scope of the invention, which is defined by the claims, which follow as interpreted under the principles of patent law including the doctrine of equivalents.

I claim:

1. A holder comprising:
a pocket for holding informational material; and
an extension extending from said pocket, said extension adapted for engagement by a window pane when the window pane is in an at least a generally closed position.

2. The holder according to claim 1, wherein said pocket is formed by at least one sheet of plastic.

3. The holder according to claim 2, wherein said sheet of plastic comprises clear plastic.

4. The holder according to claim 2, wherein said sheet of plastic forms said extension.

5. The holder according to claim 1, wherein said extension includes a looped portion, said looped portion for holding a cylindrical member wherein said cylindrical member adapts said extension for being engaged by a window pane when the window pane is in the at least generally closed position.

6. The holder according to claim 1, wherein said pocket comprises a first pocket, further comprising a second pocket.

7. The holder according to claim 6, wherein said second pocket is intermediate said first pocket and said extension.

8. The holder according to claim 6, wherein said extension includes said second pocket.

9. The holder according to claim 1, said pocket having an opening for inserting therein and retrieving therefrom the informational material from said pocket.

10. The holder according to claim 9, further comprising a cover for at least partially closing said opening.

11. The holder according to claim 10, wherein said cover includes a fastener member and said pocket includes a corresponding fastener member cooperating with said fastener member of said cover to close said opening.

12. The holder according to claim 10, wherein said fastener members comprise hook and loop members.

13. The holder according to claim 9, wherein said pocket includes an upper edge when said holder is mounted in a window, said extension extending from said upper edge.

14. The holder according to claim 13, wherein said opening is located at or near said upper edge of said pocket.

15. The holder according to claim 13, wherein said pocket includes a side edge and a bottom edge, said opening being located at or near one of said side edge and said bottom edge.

16. A holder comprising:
a first sheet of flexible material;
a second sheet of material secured to said first sheet and forming a pocket with said first sheet, said first sheet having an extension extending beyond said second sheet, said extension having a length sufficient for draping over an upper edge of a window pane;
a loop formed in said extension; and
a cylindrical member positioned in said loop and forming a stop to thereby support said holder from the window pane when said extension and said loop are draped over an upper edge of a window pane and the window pane is at least partially closed.

17. The holder according to claim 16, wherein said flexible material comprises plastic.

18. The holder according to claim 16, wherein said second sheet comprises a flexible material.

19. The holder according to claim 18, wherein said flexible material of said second sheet comprises a substantially clear flexible material.

20. The holder according to claim 16, wherein said pocket includes an open side to permit material to be inserted into or retrieved from said pocket.
